(19) United States
(12) Patent Application Publication
(10) Pub. No.: US 2004/0150525 A1
(43) Pub. Date: Aug. 5, 2004

(54) Material tracking, monitoring and management systems and methods

(76) Inventors: E. Jane Wilson, Libertyville, IL (US); Tom Dudar, Palatine, IL (US); Peter Tomicki, Janesville, WI (US); Martin Monaghan, Evanston, IL (US); Kurt Attermeier, Spring Grove, IL (US); Janet Mullan, Antioch, IL (US); Janice Frobel, Elmhurst, IL (US)

Correspondence Address: FRANCIS C. KOWALIK, ESQ., CORPORATE COUNSEL, LAW DEPARTMENT, BAXTER INTERNATIONAL INC., ONE BAXTER PARKWAY, DF2-2E, DEERFIELD, IL, 60015, US

(21) Appl. No.: 10/414,407

(22) Filed: Apr. 15, 2003

(51) Int. Cl. G08B 13/14

(52) U.S. Cl. 340/572.1; 340/825.49; 340/573.1

(57) ABSTRACT

A system and method for tracking, monitoring and managing a material are provided. The system and method include material having a radio frequency identification tag storing material information including tracking information, usage information and inventory information. A number of radio frequency identification readers are strategically placed throughout a desired environment to track and monitor the movement of the material within the desired environment. Further radio frequency identification readers throughout the desired environment are configured to track the usage of the material and to monitor the material for improper usage. Thus, the readers are able to create a comprehensive material tracking, monitoring and managing system.

### CROSS-REFERENCE TO RELATED APPLICATIONS

Not Applicable.

### FEDERALLY SPONSORED RESEARCH OR DEVELOPMENT

Not Applicable.

### BACKGROUND OF THE INVENTION

The present invention relates to systems and methods for tracking, monitoring and managing materials, and more particularly, the present invention relates to systems and methods for tracking, monitoring and managing medical materials, such as controlled substances, in a health care environment.

Historically, controlled substances are closely monitored due to federal laws governing their use. One way to monitor controlled substances is to place them in a locked cabinet and to limit access to the cabinet. This method of monitoring controlled substances can be problematic because it is very labor intensive. Further, since the inventory of controlled substances under this method is manually performed, it does not provide an automated way of verifying inventory or usage information, nor does it provide for real-time tracking information.

Accordingly, a need remains for a system and method that automates access to controlled substances and medical materials and which is able to monitor the movement of controlled substances within a desired environment. Further a need exists for a system and method that allow for real-time updating of controlled substances and medical materials usage, tracking and inventory information.

### SUMMARY OF THE INVENTION

According to one embodiment of the present invention, a material movement tracking system for tracking a movement of a medical material within a desired environment is provided. In an embodiment, the desired environment is a medical environment. The system includes a radio frequency identification tag affixed to a container holding the medical material and at least one radio frequency identification reader adapted to read and/or write information to the radio frequency identification tag when the tag comes within a predetermined range of the reader. The reader is placed in a strategic location within the desired environment, such as a portal or doorway.

The medical materials being tracked in one embodiment include controlled substances and/or therapeutic fluids. Controlled substances and therapeutic fluids include, for example, drugs, prescribed medications, saline solutions, dextrose solutions, nutritional solutions, dialysis solutions, blood, blood components, blood substitutes and the like.

The information written to the tag in one embodiment includes time information and/or location information. The location information may include a status indicator which indicates whether the container is loaded into a corresponding medical device. In addition, the location information may further include information identifying the medical device and the location of the medical device, for example, a serial number of the device and a room number where the device is located.

The reader of the system in one embodiment is configured to communicate with at least one database via a communication network, thereby enabling the reader to write information to the database, such as time information and/or location information relating to the movement of the tag. Further, the reader may be configured to be monitored and/or programmed via the communication network.

The reader may also be configured to communicate with at least one concerned party via a communication network. The concerned party could be, for example, a law enforcement department, a security department, a fire department, and a facility administrator. The reader can be programmed to contact the concerned party when a predetermined event occurs.

The information written to the tag may be read using a handheld computing device in one embodiment of the system. In addition, the information written to and read from the radio frequency identification tag may be encoded and/or encrypted.

In one embodiment according to the present invention, a material usage monitoring system is provided. The material usage monitoring system includes a radio frequency identification tag affixed to a container holding a material and a handheld computing device having a radio frequency identification reader. The handheld computing device is configured to read and write usage information to the radio frequency identification tag via the radio frequency identification reader. The system may further include at least one material database for storing material information, a communication network, and a communication device in communication with the handheld computing device. The communication device is configured to communicate the material information from the material database to the handheld computing device via the communication network.

The handheld computing device in one embodiment is a personal digital assistant and the communication device is a docking station for the personal digital assistant. Preferably, the communication device is configured to communicate information from the handheld computing device to the material database via the communication network. In one embodiment, the information communicated from the handheld computing device to the material database via the communication network includes the usage information.

Preferably, the radio frequency identification tag is configured to include patient information. In addition, the information written to and read from the radio frequency identification tag including the patient information, the usage information and the material information may be encoded and/or encrypted.

In one embodiment according to the present invention, a medical disposable monitoring system is provided. The medical disposable monitoring system includes a medical disposable having a radio frequency identification tag affixed thereto. The radio frequency identification tag stores at least one usage parameter for the medical disposable and at least one key operating parameter for the medical disposable. The usage parameters correspond to the key operating parameters. The system further includes a radio frequency identification reader for reading the usage parameters and the key operating parameter, and a computing device in communication with the radio frequency identification reader for creating an alert if at least one of the key operating parameters exceeds a limit set by the corresponding usage parameters.

The computing device in one embodiment is a handheld computing device, such as a personal digital assistant. In an alternative embodiment, the radio frequency reader and the computing device are integrated with a medical device, such as an infusion pump. Preferably all information written to and read from the radio frequency identification tag including the usage parameters and the key operating parameters is encoded and/or encrypted.

The present invention is also directed to methods of tracking a movement of a material within a desired environment, monitoring a usage of a material, and monitoring a medical disposable using the features described above.

Additional features and advantages of the present invention are described in, and will be apparent from, the following Detailed Description of the Invention and the Figures.

### BRIEF DESCRIPTION OF THE FIGURES

FIG. 1 is a schematic view of a material movement tracking system according to an embodiment of the present invention.

FIG. 2 is a schematic view of a material usage monitoring system according to an embodiment of the present invention.

FIG. 3 is a screen shot of a graphical user interface for the material usage monitoring system shown in FIG. 2.

FIG. 4 is a flowchart illustrating an embodiment of a method of monitoring a usage of a material.

FIG. 5 is a schematic view of a medical disposable monitoring system according to an embodiment of the present invention.

FIG. 6 is a flowchart illustrating a method of monitoring a medical disposable according to an embodiment of the present invention.

### DETAILED DESCRIPTION OF THE INVENTION

While this invention is susceptible of embodiment in many different forms, there is shown in the drawing, and will be described herein in detail, specific embodiments thereof with the understanding that the present disclosure is to be considered as an exemplification of the principles of the invention and is not intended to limit the invention to the specific embodiments illustrated.

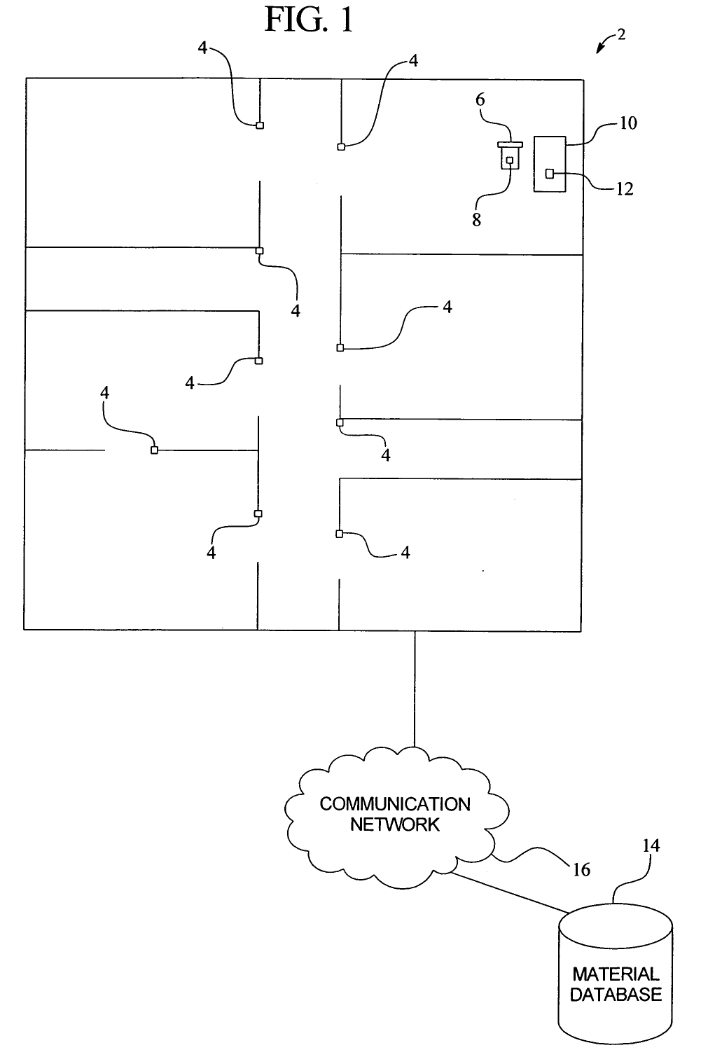

Referring to the drawings, FIG. 1 shows a schematic view disclosing functional relationships between components of one embodiment of the present invention. A material movement tracking system is generally disclosed and referred to with the reference numeral 2. The material movement tracking system 2 generally includes a number of strategically placed readers 4, a container 6 holding the material, and a label 8 affixed to the container 6.

In an embodiment, the readers 4 are radio frequency identification (RFID) readers. The readers 4 can be any suitable type of RFID reader. Generally, a RFID reader or interrogator includes electronics that have RFID read and write functionality. In an embodiment, the label 8 is a RFID tag or label. The RFID label 8 is capable of storing information provided in a machine readable format using RFID technology. Thus, the readers 4 are able to read and/or write information to the label 8.

RFID tags and labels generated using RFID technology include “smart tags” or “smart labels” such as Omron's V720 Series inlets and tags or Tag-it™ products from Texas Instrument Radio Frequency Identification Systems. RFID tags provide a large amount of data in a condensed space. Further, RFID tags have very high readability since they do not have to be oriented with respect to a reader to be scanned. As described below, information contained on an RFID tag or label can be erased, appended or rewritten.

RFID tags also offer increased flexibility, privacy and security since the data can be encoded and/or encrypted. Encoded and/or encrypted information can only be accessed with the proper encoding/encryption and decoding/decryption techniques and/or equipment. Further, various encoding and/or encryption techniques allow for the optimization of stored and transferred information. It should be appreciated that any suitable form of data encryption or encoding may be used in accordance with the present invention.

Generally, RFID tags include a transponder that allows for communication with the RFID tag. RFID tags employ transponders having various read and write functionality. For example, a transponder may be read only (R/O), read/write (R/W) or write once/read many (WORM). Further, transponders used on RFID tags have varying power sources. For instance, an active transponder is equipped with battery power, thereby providing greater reading distances while a passive transponder is powered by the RF energy emitted from a reader or interrogator, thereby providing for lower costs.

Transponders may operate at different frequency ranges. For example, a low frequency transponder may operate at about 125 kHz with a read range of about 10 cm while a high frequency transponder operates at about 13.56 MHz with a read range of about 1 m to about 5 m. Further, a transponder may even operate at an ultra high frequency within the range of 433-915 MHz and 2.45 GHz with a read range from about 3 m to about 20 m under FCC regulations.

In the embodiments described below, the material being tracked is a controlled substance, a drug, or a prescribed medication within a medical environment. However, it should be appreciated that the material could be any suitable material wherein movement or asset tracking is a desirable feature. For example, alternative embodiments include tracking a therapeutic fluid or solution. Therapeutic fluids or solutions include saline or dextrose solutions, nutritional solutions, dialysis solutions, blood, blood components, blood substitutes and the like. To the extent that the following description refers to controlled substances, drugs and/or prescribed medications, it is meant to include and apply to drug containing solutions as well as therapeutic fluid solutions.

The RFID tag or label 8 affixed to the controlled substance container 6 is preferably generated by a software interface application. However, it should be appreciated that the RFID tag 8 may be generated by any suitable hardware or software interface and/or application. For example, the RFID tag may be generated by a software interface application that utilizes the print data stream from a pharmacy information system (PIS) and incorporates the appropriate data fields into the RFID tag 8. A key benefit of this configuration is the ability to generate RFID tags integrated with text without the support of the pharmacy system vendor.

As indicated above, the readers 4 are strategically placed throughout a desired environment, which, in this embodiment, is a medical environment such as a hospital. In the embodiment shown in FIG. 1, the readers 4 are strategically placed near doorways or portals. The readers 4 are programmed to read the information stored on the label 8 when the label 8 comes within a predetermined distance of any of the readers 4. Further, in one embodiment, the readers 4 are programmed to write information to the label 8 when the label 8 comes within a predetermined distance of any of the readers 4. In an embodiment, the readers 4 write time and location information to the label 8.

In one embodiment, the location information further includes a status indicator. The status indicator indicates whether the container 6 is loaded into a corresponding medical device. For example, if the container 6 were a syringe, the status indicator could indicate whether the syringe is loaded into a corresponding medical device, such as a syringe pump. Further, the location information including the status indicator could also indicate the location and identification information for the particular medical device that the specified container 6 is loaded into. For instance, the location information could indicate that the specified syringe is loaded into a syringe pump in a particular room on a particular floor.

Since the readers 4 are placed near doorways or portals, the readers 4 are able to read and/or write information to the label 8 any time that the container 6 bearing the label 8 passes through any of the doorways or portals that are associated with one of the readers 4. In this manner, the readers 4 are able to map the travel of the container 6 and the controlled substance contained within throughout the desired environment. Thus, the tracking system serves to help locate the controlled substance and to help prevent theft or unauthorized use of the controlled substance within the desired environment.

In an embodiment, the system includes a home base 10 such as a cabinet or a locker. When the container 6 is returned to the home base 10, the reader 12 reads the information contained in the label 8 and writes time and location information to the label 8. Thus, the system is able to identify whether the container 6 is currently at the home base 10 and at what time the container 6 was removed and/or returned to the home base 10. In this manner, the system is able to provide real-time location information for the container 6 and the controlled substance contained within.

In an embodiment, all of the readers 4 and 12 are configured to communicate with a material database 14 via a communication network 16. The material database 4 stores information relating to all of the materials being tracked. The readers 4 and 12 are programmed to write information, such as time and location information for the container 6, to the material database 14 via the communication network 16. In turn, the information contained in the material database 14 can be used to track and analyze the movement of the container 6 throughout the desired environment.

Further, it should be appreciated that the readers 4 and 12 in communication with the material database 14 can be used to actively track and even to prohibit the movement of the container 6. For example, the material database 14 could be programmed to lock doors based on the movement of the container 6. For example, when the container 6 is moved beyond a permissible location, the material database 14 would lock selected doors near the location of the container 6 to prevent the container 6 from being removed from the premises.

Further, the readers 4 and 12 can also be programmed to read information from a security badge carried by facility personnel. In general, many facilities including hospitals and medical facilities employ security badges that utilize RFID technology. Thus, the readers 4 and 12 could be configured to recognize the label 8 as well as security badges. Therefore, if an unauthorized user removes the container 6 from the home base 10, the material database 14 recognizes this unauthorized movement and locks the unauthorized user in a room while security personnel are alerted. Alternatively, the material database alerts security personnel without locking the unauthorized user in the room. Thus, the material database is able to compare personnel information contained on the security badge with material information contained on the label 8 to prevent the unauthorized movement of the container 6 and the controlled substance contained within. Alternatively, the material database reads the personnel information and/or the material information and unlocks doors and/or cabinets to allow authorized personnel to access the container 6 and/or the home base 10.

It should be appreciated that various controlled substances could be associated with various facility personnel. For example, an anesthetist would have greater access to anesthesia drugs whereas an orderly would have little or no access to any controlled substances. In one embodiment, the RFID tag 8 is affixed to or contained within the controlled substance or therapeutic fluid.

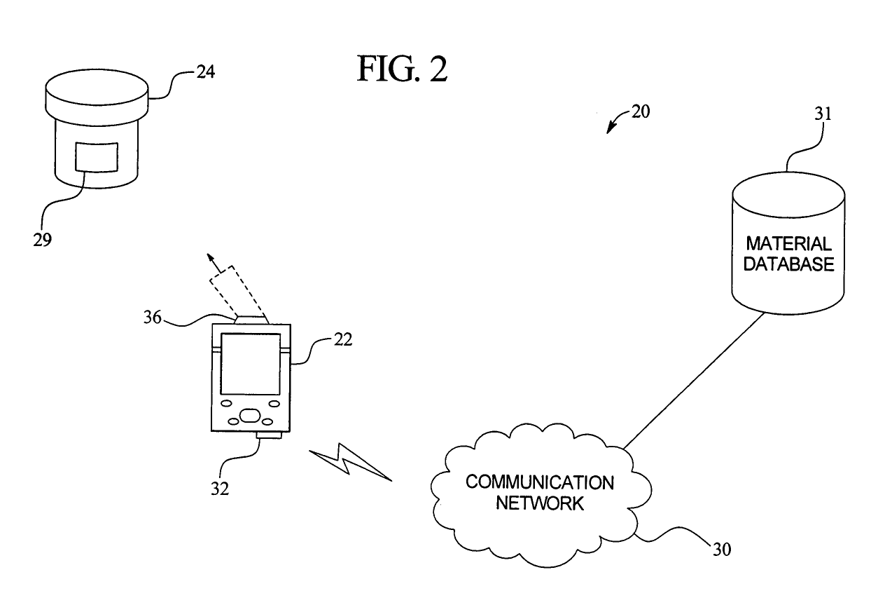

In an embodiment, the RFID tag or label 8 is designed to store usage information in addition to tracking information. Referring now to FIG. 2, a usage monitoring system is generally disclosed and referred to with the reference numeral 20. The usage monitoring system 2 generally includes a handheld computing device 22, a container 24 with a RFID tag 29 affixed thereto, a communication network 30 and a material database 31. The medication container 24 is shown as a bottle, but it should be appreciated that the medication container 24 in alternative embodiments can include any suitable type of container including medication containers such as IV containers, syringes, vials, and the like.

In an embodiment, the container 24 contains a prescribed medication, a drug or a controlled substance. Information regarding the medication, which includes usage data for the particular medication is contained in the RFID tag 29. The tag 29 is preferably generated by a pharmacist preparing the medication who also attaches the tag 29 to the medication container 24. Alternatively, the tag 29 can generated by an external source such as the National Data Corporation (NDC) in the form of a NDC label and applied to the container 24 by a drug manufacturer. In alternative embodiments, the medication information further includes instructions on how the medication is to be delivered, whether it be manually or by a medication delivery device. Further, the medication information may include but is not limited to drug name, drug amount, diluent amount, and route of administration. If the drug is solely to be used for a particular patient, the medication information may include patient name, patient identification number, physician name, order number, and date.

Optional text information may also be included in the tag 29, such as patient name, patient identification number, physician name, drug name, diluent name, cautions, expiry, delivery time, location, prepared date, prepared time, and preparer identification. The pharmacy that generates the first label preferably includes a pharmacy information system (not shown) having a printer port. In one embodiment, the printer is connected directly to the printer port. In an alternate embodiment, the pharmacy information is configured to also communicate the actual medication information to the handheld computing device 22.

The handheld computing device 22 reads the medication information including the usage data through a first information input device 36 integrated into the handheld computing device 22. The input device 36 may be a RFID reader or interrogator. Further, the handheld computing device 22 is equipped with a storage device for storing information. The storage device can be any suitable storage device such as fixed or removable optical and magnetic memory and the like. The handheld computing device 22 is also configured to communicate with other electronic devices using, for example, a transceiver such as an infrared transceiver, a radio frequency transceiver and the like.

Suitable handheld computing devices include but are not limited to laptop, tablet or palmtop computers such as a personal digital assistants (PDA). Examples of a PDA include a Palm Handheld, various handheld devices from Handspring, and Pocket PC models from Compaq and Hewlett-Packard. It should be appreciated that any suitable brand of PDA is capable of being used. A PDA is advantageous in that it can be easily and inexpensively configured to meet the needs of the present invention. An additional advantage is that a PDA can be upgraded to provide, among other things, additional software applications and hardware devices.

In one embodiment, the first information input device 36 is integrated into the handheld computing device 22. Alternatively, the input device 36 is in the form of a detachably receivable expansion module. The input device 36 corresponds to the machine readable format selected for the medication information and the patient data, for example, a smart tag reader or a radio frequency identification reader such as the Hand'IT™ contactless reader by Inside Technologies.

Once the medication information is captured by the handheld computing device 22 via the first information input device 36, the information in one embodiment is stored in the handheld computing device 22. As stated above, the storage device of the handheld device 22 includes various types of memories such as hard drive, a floppy disk, a compact disc, an optical medium, magnetic storage, and the like.

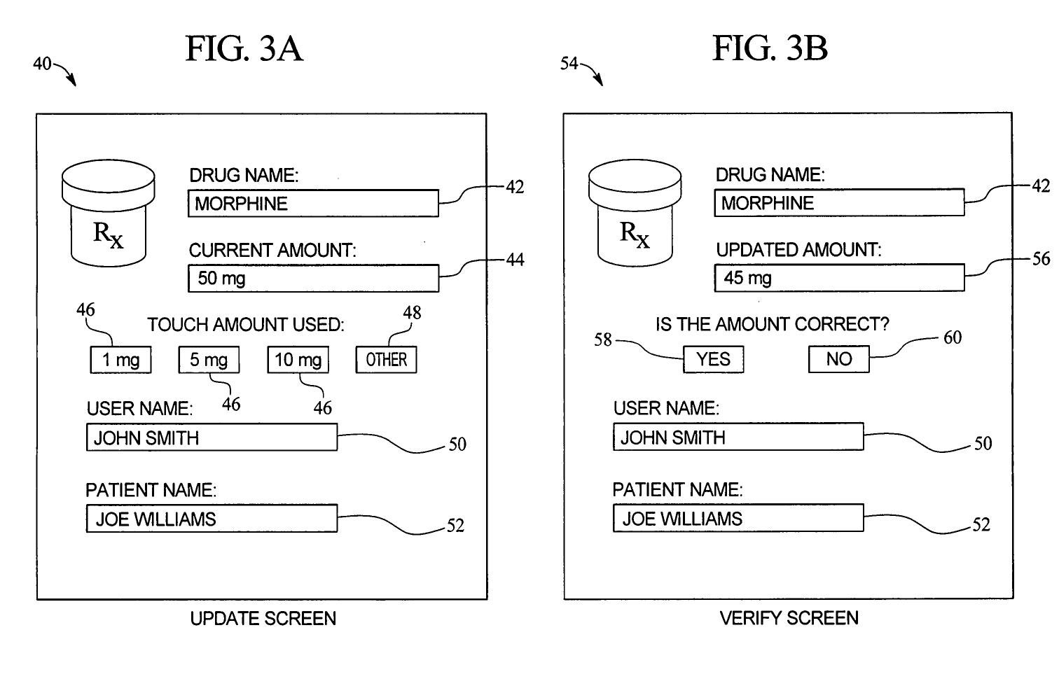

In one embodiment, a software application guides the care provider or nurse clinician through the process of administering the prescribed medication and updating the usage data. FIGS. 3A and 3B illustrate screen shots of a graphical user interface for a software application of a material usage monitoring system according to an embodiment of the present invention.

Once the care provider reads the tag 29 with the handheld computing device 22, the software application on the handheld computing device displays the update screen 40 as shown in FIG. 3A. The update screen 40 displays a drug name 42 and a current drug amount 44. In an alternative embodiment, the update screen 40 can display other information regarding the drug such as the drug percentage or the expiration date. In an embodiment, the update screen 40 also displays a user name 50 (i.e., the name of the care provider) and a patient name 52. By displaying all of these identifying criteria 42, 44, 50 and 52, the care provider is able to verify that the correct drug is being delivered to the proper patient. Further, by creating a record containing all of this information, an accurate medical history is produced.

The care provider then administers the drug to the patient. The care provider then enters the amount of the drug being used by pressing preset amount buttons 46 or other amount button 48. The preset amount buttons 46 correspond to the preset amount displayed on the update screen 40 while the other amount button 48 allows the care provider to enter any suitable amount up to the current amount 44. It should be appreciated that the care provider, instead of administering the drug to the patient, could set aside an amount for later use. Either way, the care provider uses the amount buttons 46 and 48 to update the amount of the prescribed medication contained in the container 24.

After entering the amount of the prescribed medication that was used, the care provider is asked to verify the amount using a verify screen 54. As with the update screen 40, the verify screen 54 displays the drug name 42, the user name 50 and the patient name 52. However, instead of displaying a current amount, the verify screen 54 displays an updated amount 56. The user or care provider is then asked to verify this amount by entering yes button 58 or no button 60. If the user presses the yes button 58, the updating process is complete. If the user presses the no button 60, then they are taken once again to the update screen 40 to repeat the entire process.

It should be appreciated that the above-described embodiment of a material usage monitoring system is applicable to any suitable type of material or medical material including blood and blood components. Further, it should be appreciated that the system is equally applicable to a wholesale environment such as a pharmacy, wherein the pharmacy distributes materials including controlled substances to various departments within, for example, a hospital. Thus, the department would take the place of the patient and the pharmacist or pharmacy worker would be the user, rather than a care provider, as described in the above embodiment.

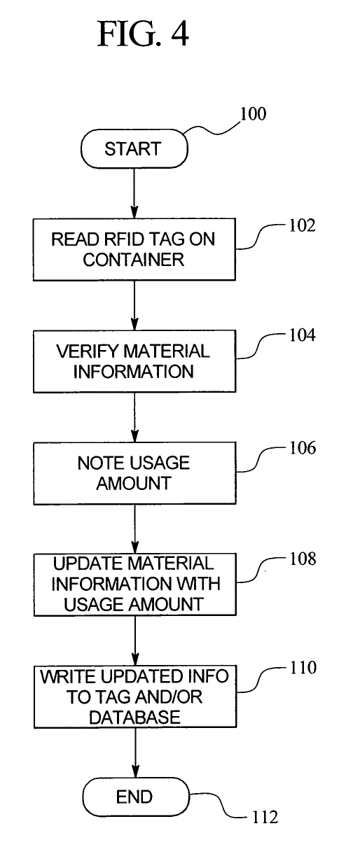

FIG. 4 is a flowchart illustrating an embodiment of a method of monitoring a usage of a material. In an embodiment, the method shown in FIG. 4 is performed using the system described with reference to FIGS. 2 and 3. The method starts at step 100. At step 102, the RFID tag on the container is read, thereby displaying the material information for the material contained in the container. The material information is verified at step 104. It should be appreciated that the material information can display a number of suitable identifiers that will allow one to verify the material. Further, it should be appreciated that all of the information may be stored on the RFID tag. Alternatively, select information could be stored on the RFID tag and the remaining information can be accessed from a material database via a communication network.

At step 106, the usage amount of the material is noted. It should be appreciated that the usage amount does not necessarily have to be used at the time the usage amount is noted. The material information is updated with the usage amount at step 108. At step 110, the updated material information is written to the RFID tag and/or the material database. It should be appreciated that steps 108 and 110 could be combined into one step to simplify the procedure. Further, it should be appreciated that the RFID tag does not have to be updated if all of the amount information is stored on the material database rather than the RFID tag. The method of monitoring a usage of a material ends at step 112.

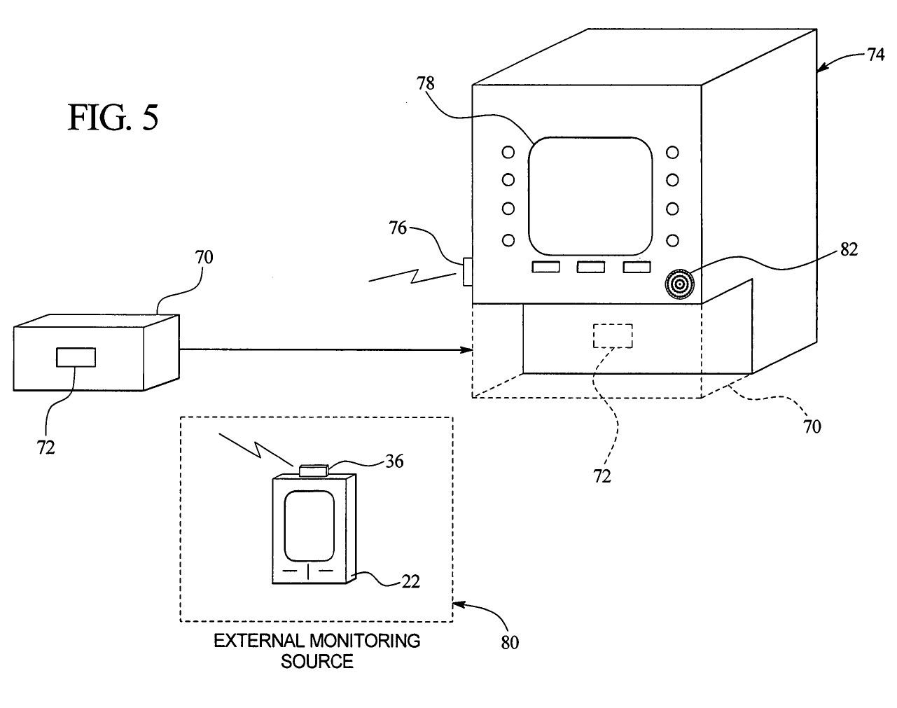

FIG. 5 illustrates a medical disposable monitoring system according to an embodiment of the present invention. In general, the medical disposable monitoring system includes a medical disposable 70 equipped with an RFID tag 72 and a medical device 74 equipped with an RFID reader 76. Alternatively, the medical disposable monitoring system includes an external monitoring source 80 which, in an embodiment, is a handheld computing device 22 equipped with an RFID reader 36. The RFID tag 72, the RFID readers 36 and 76, and the handheld computing device 22 are substantially similar to those described in the above embodiments and their description will therefore be omitted.

The medical disposable 70 can be any suitable medical disposable including, for example, hemodialysis cartridges, ventilator tubing, bags, sets, suction canisters and catheters. The medical device 74 can be any suitable medical device that is adapted to receive and use a medical disposable such as those described above. The RFID tag 72 affixed to the medical disposable 70 stores information relating to the medical disposable 70. In one embodiment, the RFID tag 72 stores usage parameters for the medical disposable 70. The usage parameters include any suitable usage parameter such as an expiration date and/or life expectancy (i.e., length of time or number of uses) and a temperature range and/or limit. The usage parameters can be programmed to the RFID tag 72 by a variety of suitable parties including the manufacturer of the medical disposable 70 and an administrator at a clinical facility where the medical disposable 70 will be used. It should be appreciated that the usage parameters can be reprogrammed and/or customized to allow an administrator and/or a manufacturer to set higher safety standards for the use of the medical disposable 70.

In an embodiment, the RFID tag 72 further stores key factors relating to the use of the medical disposable 70. Preferably, these key factors correspond, in category, to the usage parameters described above. The key factors are written to the RFID tag 72 with each use of the medical disposable 70. Thus, the key factors create an ongoing usage history for the medical disposable 70.

The medical disposable monitoring system works in the following manner. The medical disposable 70 is selected and brought towards the medical device 74 to be inserted as shown in FIG. 5. As the medical disposable 70 nears the medical device, the RFID reader 76 reads the usage parameters and the key factors from the RFID tag 72. The medical device compares the key factor to the usage parameters to make sure that the key factors are within the ranges set by the usage parameters.

If any of the key factors are outside the ranges set by the usage parameters, the medical device 74 creates an alert. For example, the medical device 74 could display a visual alert on display 78 or an audio alert through speaker 82. In an embodiment, the medical device creates both an audio and a visual alert. The visual alert, displayed on display 78, includes information detailing which usage parameter has been exceed and presents instructions as to how to proceed. In an embodiment, the audio alert also provides information detailing which usage parameter has been exceeded and presents instructions as to how to proceed. Preferably, the alert created by the medical device 74 instructs the user to dispose of the medical disposable 70 and to obtain a new or different medical disposable to continue the chosen therapy.

In an embodiment, a user lock-out is created when the medical device 74 reads a key factor outside the range set by the usage parameters. Essentially, the medical device 74 shuts down and does not allow the user to insert the medical disposable 70 into the medical device 74. In an embodiment, the user must manually press an override key (not shown) to disable the lockout. In an embodiment, the user must manually key in a password to override the lockout. The password, in an embodiment, is only known by an administrator, thereby creating an extra level of safety.

If the key factors are all within the ranges set by the usage parameters, then the therapy provided by the medical device 74 is able to be performed. After the therapy is performed, the medical device 74 writes the key factors of the usage of the medical disposable 70 to the RFID tag 72. Alternatively, the medical device periodically updates the RFID tag 72 during the therapy to create a record of the progress of the therapy in case the therapy is interrupted.

In an alternative embodiment, the medical device 74 does not read the RFID tag 72. Instead, the external monitoring source 80 such as an the RFID reader 36 and the handheld computing device 22 perform the same tasks that are performed by RFID reader 76 and the medical device 74. Thus, the RFID reader 36 reads the RFID tag 72 and the handheld computing device 22 creates an alert if the key factors exceed the ranges set by the usage parameters. A detailed description of the remaining functions of the RFID reader 36 and the handheld computing device 22 are omitted as they essentially duplicate the functions described above with reference to the RFID reader 76 and the medical device 74.

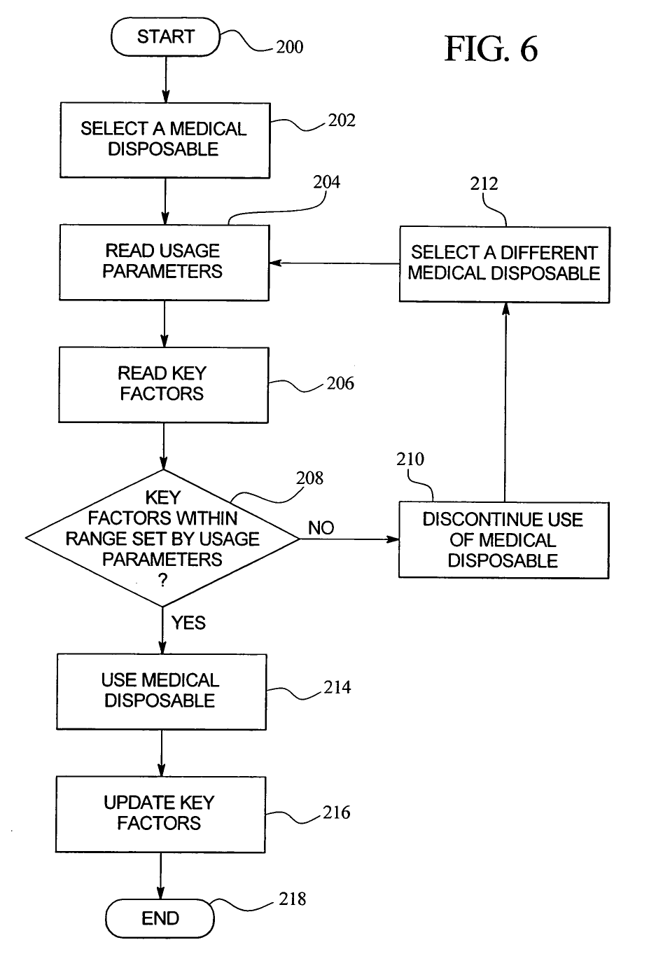

FIG. 6 is a flowchart illustrating a method of monitoring a medical disposable according to an embodiment of the present invention. In an embodiment, the monitoring system shown in FIG. 5 performs the method. The method starts at step 200. At step 202, a medical disposable is selected. The usage parameters are read from an RFID tag on the medical disposable 70 at step 204. As described above, the usage parameters can be read by a medical device 74 equipped with an RFID reader 76 or by an external monitoring source 80 such as a handheld computing device 22 equipped with an RFID reader. The key factors are read from the RFID tag at step 206. It should be appreciated that steps 204 and 206 could be combined into one reading step.

Once the key factors and the usage parameters are read, the key factors are compared to the usage parameters to determine whether any of the key factors fall outside the ranges set by the usage parameters. If any one of the key factors fall outside the ranges set by the usage parameters, the user is prompted to dispose of the medical disposable 70 at step 210. The user must then select a different or new medical disposable at step 212 and proceed back to step 204.

If the key factors fall within the range set by the usage parameters, then the user is free to use the medical disposable at step 214. It should be appreciated that step 214 further includes the step of measuring the key factors of the use of the medical disposable. Once the medical disposable has been used, the RFID tag 72 is updated, at step 216, with the key factors from the use of the medical disposable during step 214. The method then ends at step 218.

It should be appreciated that any of the RFID tags described above may be further used to provide an inventory system that can be seamlessly integrated with the tracking, usage and disposable monitoring systems described above. Thus, a hospital administrator or the like would be able to view and compile inventory information across a number of hospital departments. This information could be used for material and supply ordering as well as for organizing a just-in-time system for supplying the materials.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A material movement tracking system for tracking a movement of a medical material within a desired environment, the system comprising:
a radio frequency identification tag affixed to a container holding the medical material; and
at least one radio frequency identification reader adapted to at least one of read and write information to the radio frequency identification tag when the tag comes within a predetermined range of the reader, the reader being placed in a strategic location within the desired environment.

2. The material movement tracking system as claimed in claim 1, wherein the medical material is selected from the group consisting of controlled substances and therapeutic fluids.

3. The material movement tracking system as claimed in claim 1, wherein the information written to the tag includes at least one of time information and location information.

4. The material movement tracking system as claimed in claim 3, wherein the location information further includes a status indicator, the status indicator indicating whether the container is loaded into a corresponding medical device.

5. The material movement tracking system as claimed in claim 4, wherein the location information further includes information identifying the medical device and the location of the medical device.

6. The material movement tracking system as claimed in claim 1, wherein the reader is configured to communicate with at least one database via a communication network.

7. The material movement tracking system as claimed in claim 6, wherein the reader writes to the database at least one of time information and location information relating to the movement of the tag.

8. The material movement tracking system as claimed in claim 6, wherein the reader is configured to be at least one of monitored and programmed via the communication network.

9. The material movement tracking system as claimed in claim 1, wherein the reader is configured to communicate with at least one concerned party via a communication network.

10. The material movement tracking system as claimed in claim 9, wherein the concerned party is selected from the group consisting of a law enforcement department, a security department, a fire department, and a facility administrator.

11. The material movement tracking system as claimed in claim 9, wherein the reader contacts the concerned party when a predetermined event occurs.

12. The material movement tracking system as claimed in claim 1, wherein the information written to the tag is read using a handheld computing device.

13. The material movement tracking system as claimed in claim 1, wherein the strategic location within the desired environment is a portal.

14. The material movement tracking system as claimed in claim 1, wherein the information written to and read from the radio frequency identification tag is at least one of encoded and encrypted.

15. A method of tracking a movement of a material within a desired environment, the method comprising the steps of:
placing at least one radio frequency identification reader in a strategic location within the desired environment, the reader designed to read a radio frequency identification tag affixed to a container holding the material;
reading the tag when the tag comes within a predetermined area surrounding the reader; and
writing information to the tag each time the tag comes within the predetermined area surrounding the reader.

16. The method of tracking a movement of a material within a desired environment as claimed in claim 15, wherein the material is selected from the group consisting of controlled substances and therapeutic fluids.

17. The method of tracking a movement of a material within a desired environment as claimed in claim 15, wherein the information written to the tag includes at least one of time information and location information.

18. The method of tracking a movement of a material within a desired environment as claimed in claim 17, wherein the location information further includes a status indicator, the status indicator indicating whether the container is loaded into a corresponding medical device.

19. The method of tracking a movement of a material within a desired environment as claimed in claim 18, wherein the location information further includes information identifying the medical device and the location of the medical device.

20. The method of tracking a movement of a material within a desired environment as claimed in claim 15, wherein the reader is configured to communicate with at least one database via a communication network.

21. The method of tracking a movement of a material within a desired environment as claimed in claim 20, further comprising the step of writing at least one of time information and location information relating to the movement of the tag to the database.

22. The method of tracking a movement of a material within a desired environment as claimed in claim 20, wherein the reader is configured to be at least one of monitored and programmed via the communication network.

23. The method of tracking a movement of a material within a desired environment as claimed in claim 15, wherein the reader is configured to communicate with at least one concerned party via a communication network.

24. The method of tracking a movement of a material within a desired environment as claimed in claim 23, wherein the concerned party is selected from the group consisting of a law enforcement department, a security department, a fire department, and a facility administrator.

25. The method of tracking a movement of a material within a desired environment as claimed in claim 23, the method further comprising the step of contacting the concerned party when a predetermined event occurs.

26. The method of tracking a movement of a material within a desired environment as claimed in claim 15, further comprising the step of reading the information written to the tag.

27. The method of tracking a movement of a material within a desired environment as claimed in claim 15, wherein the step of reading the information written to the tag is performed using a handheld computing device.

28. The method of tracking a movement of a material within a desired environment as claimed in claim 15, wherein the strategic location within the desired environment is a portal.

29. The method of tracking a movement of a material within a desired environment as claimed in claim 15, wherein the information written to and read from the radio frequency identification tag is at least one of encoded and encrypted.

30. A material usage monitoring system, comprising:
a radio frequency identification tag affixed to a container holding a material; and
a handheld computing device having a radio frequency identification reader, the handheld computing device being configured to read and write usage information to the radio frequency identification tag via the radio frequency identification reader.

31. A material usage monitoring system as claimed in claim 30, further comprising:
at least one material database, the material database storing material information;
a communication network; and
a communication device in communication with the handheld computing device, the communication device being configured to communicate the material information from the material database to the handheld computing device via the communication network.

32. A material usage monitoring system as claimed in claim 31, wherein the handheld computing device is a personal digital assistant and the communication device is a docking station for the personal digital assistant.

33. A material usage monitoring system as claimed in claim 31, wherein the communication device is further configured to communicate information from the handheld computing device to the material database via the communication network.

34. A material usage monitoring system as claimed in claim 33, wherein the information communicated from the handheld computing device to the material database via the communication network includes the usage information.

35. A material usage monitoring system as claimed in claim 30, wherein the radio frequency identification tag includes patient information.

36. A material usage monitoring system as claimed in claim 31, wherein the usage information and material information written to and read from the radio frequency identification tag is at least one of encoded and encrypted.

37. A method of monitoring a usage of a material, the method comprising the steps of:
reading usage data stored in a radio frequency identification tag affixed to a container holding the material, the usage data including a current amount of the material in the container;
noting a usage amount of the material; and
writing usage information to the tag, the usage information reflecting an updated amount which includes the usage amount subtracted from the current amount.

38. The method of monitoring a usage of a material as claimed in claim 37, wherein the material is selected from the group consisting of controlled substances and therapeutic fluids.

39. The method of monitoring a usage of a material as claimed in claim 37, wherein a handheld computing device performs the steps of reading information from and writing information to the tag.

40. The method of monitoring a usage of a material as claimed in claim 37, wherein a handheld computing device writes the current amount to the tag and an electronic delivery device writes the usage information to the tag.

41. The method of monitoring a usage of a material as claimed in claim 37, wherein the step of reading the tag includes verifying the material.

42. The method of monitoring a usage of a material as claimed in claim 37, wherein the information written to and read from the radio frequency identification tag is at least one of encoded and encrypted.

43. A medical disposable monitoring system, comprising:
a medical disposable having a radio frequency identification tag affixed thereto, the radio frequency identification tag storing at least one usage parameter for the medical disposable and at least one key operating parameter for the medical disposable, the usage parameters corresponding to the key operating parameters;
a radio frequency identification reader for reading the usage parameters and the key operating parameters; and
a computing device in communication with the radio frequency identification reader for creating an alert if at least one of the key operating parameters exceeds a limit set by the corresponding usage parameters.

44. A medical disposable monitoring system as claimed in claim 43, wherein the computing device is a handheld computing device.

45. A medical disposable monitoring system as claimed in claim 44, wherein the handheld computing device is a personal digital assistant.

46. A medical disposable monitoring system as claimed in claim 43, wherein the radio frequency reader and the computing device are integrated with a medical device.

47. A medical disposable monitoring system as claimed in claim 43, wherein information written to and read from the radio frequency identification tag including the usage parameters and the key operating parameters is at least one of encoded and encrypted.

48. A method of monitoring a medical disposable, the method comprising the steps of:
reading a radio frequency identification tag affixed to the medical disposable before each use of the medical disposable, the tag storing at least one usage parameter for the medical disposable and at least one key operating parameter for the medical disposable, the usage parameters corresponding to the key operating parameters; and
creating an alert when at least one of the key operating parameters exceeds a limit set by the corresponding usage parameters;

49. A method of monitoring a medical disposable as claimed in claim 48, wherein the usage parameters are preset by a manufacturer of the medical disposable.

50. A method of monitoring a medical disposable as claimed in claim 48, wherein the usage parameters are capable of being customized.

51. A method of monitoring a medical disposable as claimed in claim 48, wherein the key operating parameters are written to the tag during a use of the medical disposable.

52. A method of monitoring a medical disposable as claimed in claim 48, wherein information written to and read from the radio frequency identification tag including the usage parameters and the key operating parameters is at least one of encoded and encrypted.
